(19) United States
(12) Patent Application Publication
(10) Pub. No.: US 2026/0011515 A1
(43) Pub. Date: Jan. 8, 2026

(54) Sealed Contactor with External Fuse

(71) Applicant: TE Connectivity Solutions GmbH, Schaffhausen (CH)

(72) Inventor: Marcus PRIEST, Carpinteria, CA (US)

(73) Assignee: TE Connectivity Solutions GmbH, Schaffhausen (CH)

(21) Appl. No.: 18/764,428

(22) Filed: Jul. 5, 2024

(51) Int. Cl. H01H 9/10; H01H 1/20; H01H 9/38; H01H 85/165

(52) U.S. Cl. CPC H01H 9/10; H01H 1/20; H01H 9/38; H01H 85/165

(57) ABSTRACT

An embodiment is directed to a contactor assembly which is adapted for switching power to a circuit having a power source. The contactor assembly includes a housing defining an interior compartment. Carry contacts and arc are positioned in the interior compartment of the housing. At least one arc contact has an overcurrent protection device positioned outside of the interior compartment of the housing. As an actuator assembly is moved toward the closed position, the actuator assembly makes an electrical connection with the arc contacts prior to making an electrical connection with the current carry contacts, and as the actuator assembly is moved toward the open position, the actuator assembly maintains an electrical connection with the arc contacts after breaking an electrical connection with the current carry contacts, prior to breaking the electrical connection with the arc contacts.

### FIELD OF THE INVENTION

The invention relates generally to switches for electric circuits, and more particularly to contactor assemblies.

### BACKGROUND OF THE INVENTION

Some known electric circuits include contactors that control the flow of current through the circuit. The contactors control current flow through the circuit by opening or closing a conductive pathway that extends through the contactor to correspondingly open or close the circuit.

In circuits that convey relatively high levels of direct current, electric arcs may be generated inside the contactors when the contactor switches from a closed state to an open state to open the circuit. When the contactors change from the closed state to the open state, an electric arc may radiate from the contacts in the contactor when current is interrupted. The electric arc can be of relatively high energy. If the arc is of sufficiently high energy, the arc can damage and/or contaminate the contacts in the contactor, and/or cause an over-pressure leading to explosion of the device.

Some known contactors that are able to withstand relatively large currents are large, heavy, and expensive to manufacture. The contactors may include relatively large contacts, actuator mechanisms, and/or arc dissipation members that are heavy and/or expensive to produce. Other smaller and/or lighter contactors are unable to withstand relatively large currents due to the significant electrical arcs. The contacts and/or arc dissipation members in these contactors are more easily damaged by the electrical arcs radiating from the contacts. Additionally, some of the contacts may be separated from one another and open the circuit when the contacts first come into contact with one another. The arc that emanates from the contacts may blow the contacts apart from one another if the arc is not dissipated rapidly.

It would, therefore, be beneficial to provide a smaller, lighter, and/or less expensive contactor that is able to safely turn on and off relatively large electric currents while avoiding welding, excessive arcing damage to the contacts in the contactor, and/or explosion of the contactor due to over-pressure caused by the arcing. In particular, it would be beneficial to provide an integrated device, such as a fuse, which is external of the contactor which can protect the contactor from excessive arcing and which can be easily replaced if excessive arcing occurs.

### SUMMARY OF THE INVENTION

An embodiment is directed to a contactor assembly which is adapted for switching power to a circuit having a power source. The contactor assembly includes a housing defining an interior compartment. Carry contacts are positioned in the interior compartment of the housing. Arc contacts are positioned in the interior compartment. At least one arc contact has an overcurrent protection device positioned outside of the interior compartment of the housing. An actuator assembly is movable in the interior compartment between an open position and a closed position. As the actuator assembly is moved toward the closed position, the actuator assembly makes an electrical connection with the arc contacts prior to making an electrical connection with the current carry contacts.

An embodiment is directed to a contactor assembly adapted for switching power to a circuit having a power source. The contactor assembly includes a housing defining an interior compartment. Carry contacts are provided in the interior compartment of the housing. Arc contacts are positioned in the interior compartment. At least one arc contact has an overcurrent protection device positioned outside of the interior compartment of the housing. The overcurrent protection device is positioned in an overcurrent protection device housing provided outside of the housing of the contactor assembly. An actuator assembly is provided in the interior compartment and is movable between an open position and a closed position. The actuator assembly has an electrical contact bridge configured to be in selective communication with the carry contacts and the arc contacts. As the actuator assembly is moved toward the closed position, the actuator assembly makes an electrical connection with the arc contacts prior to making an electrical connection with the current carry contacts. As the actuator assembly is moved toward the open position, the actuator assembly maintains an electrical connection with the arc contacts after breaking an electrical connection with the current carry contacts, prior to breaking the electrical connection with the arc contacts.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative contactor assembly in accordance with one embodiment of the present disclosure.

FIG. 2 is a top view of the contactor assembly shown in FIG. 1.

FIG. 3 is a side view of the contactor assembly of FIG. 1.

FIG. 4 is a cross-sectional view of the contactor assembly along line 4-4 shown in FIG. 2, showing the arc contacts in a closed position and the carry contacts in an open position.

FIG. 5 is a cross-sectional view of the contactor assembly along line 5-5 shown in FIG. 2, showing the arc contact and the carry contacts in a closed position.

FIG. 6 is a cross-sectional view of the contactor assembly along line 6-6 shown in FIG. 2, showing the carry contacts in an open position.

FIG. 7 is a cross-sectional view of the contactor assembly along line 7-7 shown in FIG. 2, showing the arc contact in an open position.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

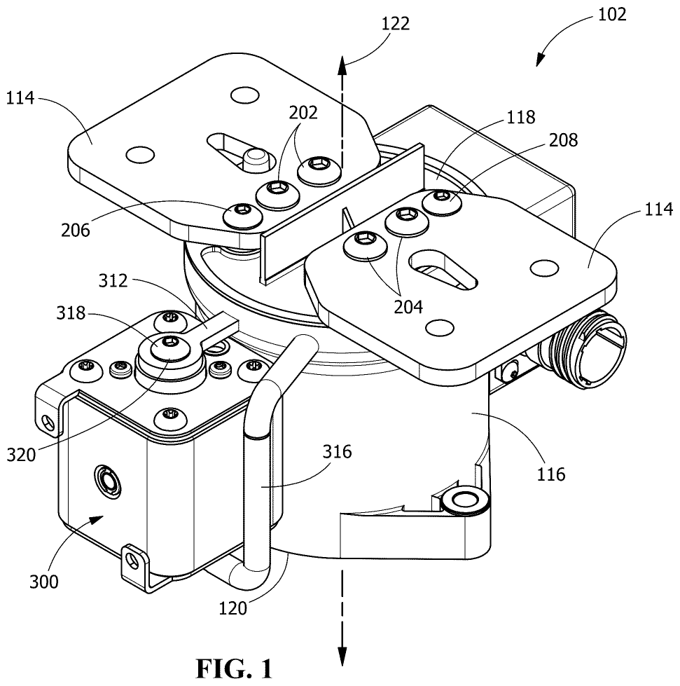

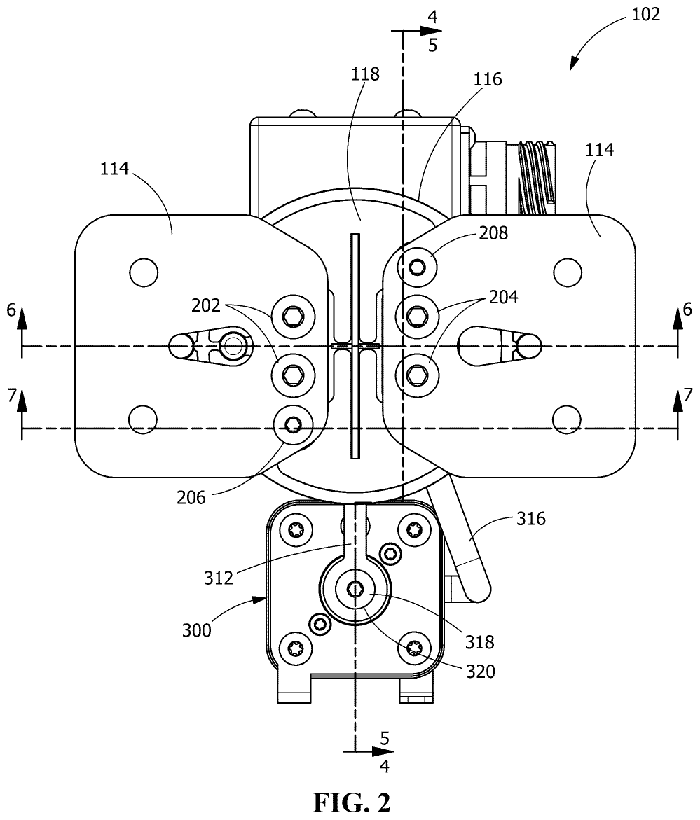

FIGS. 1 through 7 illustrate an illustrative power switch or contactor assembly 102 in accordance with one embodiment of the present disclosure. The contactor assembly 102 is in electrical engagement with a power source (not shown). The power source may be any of a variety of systems, devices, and apparatuses that supply electric current to power an electrical load (not shown). For example, the power source may be a device which supplies high voltage current, such as, but not limited to a current of at least approximately 270 volts and/or 6,000 amps, to one or more electrical components.

The contactor assembly 102 is a relay or switch that controls the delivery of power from the power source to the electrical load. In the illustrated embodiment, bus bars 114 couple the contactor assembly 102 to the power source and the electrical load. Alternatively, a different number of bus bars 114 may be used or a different component or assembly may be used to electrically join the contactor assembly 102 with the power source and the electrical load. The contactor assembly 102 alternates between open and closed states. In a closed state, the contactor assembly 102 provides a conductive bridge between the bus bars 114, in order to close the circuit and permit current to be supplied from the power source to the electrical load. In an open state, the contactor assembly 102 removes the conductive bridge between the bus bars 114, such that the circuit is opened and current cannot be supplied from the power source to the electrical load via the contactor assembly 102.

The contactor assembly 102 includes an outer housing 116 that extends between opposite ends 118, 120 along a longitudinal axis 122 (FIG. 1). While the outer housing 116 is shown in the approximate shape of a cylindrical can, alternatively the outer housing 116 may have a different shape. The outer housing 116 may include, or be formed from, a dielectric material such as one or more polymers. In another embodiment, the outer housing 116 may include or be formed from conductive materials, such as one or more metal alloys.

The contactor assembly 102 includes one or more sets of carry contacts 202, 204 and one or more sets of arc contacts 206, 208 that convey current through the contactor assembly 102. The carry and arc contacts 202-208 close and open the circuit. When the carry and arc contacts 202-208 close the circuit, the arc contacts 206, 208 close the circuit before the carry contacts 202, 204. The initial transfer of relatively high current that is supplied by the power source across the arc contacts 206, 208 may cause the arc contacts 206, 208 to arc, or create an electric arc that extends from one or more of the arc contacts 206, 208 within the contactor assembly 102. For example, the gas or atmosphere within the contactor assembly 102 that surrounds the arc contacts 206, 208 may electrically break down and permit the electric charge surging through the arc contacts 206, 208 to jump or move across the gas or atmosphere. The arcing may produce an ongoing plasma discharge that results from current flowing through normally nonconductive media such as the gas or atmosphere. The arcing can result in a very high temperature that may be capable of melting, vaporizing, or damaging components within the contactor assembly 102, such as the carry contacts 202, 204. In accordance with one or more embodiments described here, the contactor assembly 102 includes features that direct the electric arc away from the carry contacts 202, 204 and/or dissipates the electric arc such that the electric arc does not damage or contaminate the carry contacts 202, 204.

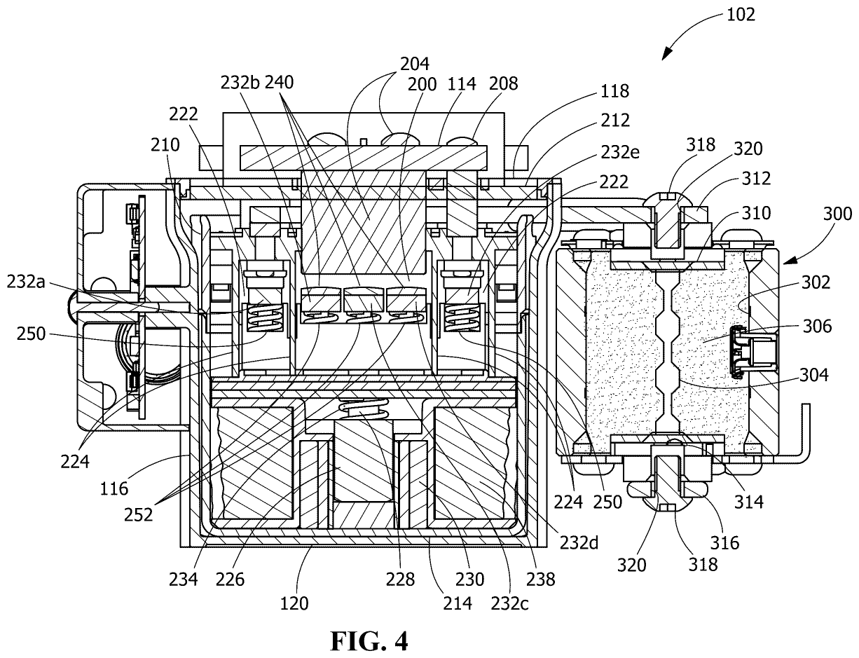

As shown in FIGS. 4 through 7, the contactor assembly 102 includes an inner housing 210 disposed within the outer housing 116. The inner housing 210 may extend between opposite ends 212, 214 along the longitudinal axis 122. The carry and arc contacts 202-208 protrude through the end 212 of the inner housing 210 to be presented at the end 118 of the outer housing 116. The inner housing 210 may include, or be formed from, a dielectric material such as one or more polymers. In another embodiment, the inner housing 210 may include or be formed from conductive materials, such as one or more metal alloys.

The inner housing 210 includes a carry contact interior compartment 220 and one or more arc contact interior compartments 222. The carry contact interior compartment 220 and the one or more arc contact interior compartments 222 are separated by interior walls 224. The interior walls 224 may include, or be formed from, a dielectric material such as one or more polymers or insulative materials such as ceramics.

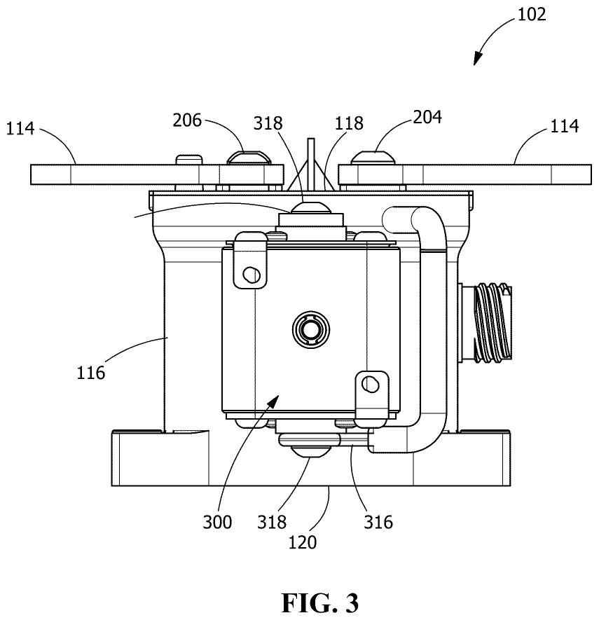

As shown in FIG. 3, the carry contacts 202, 204 are disposed in the carry contact interior compartment 220 and the arc contacts 206, 208 are disposed in the arc contact interior compartments 222. The interior compartments 220, 222 may be sealed and loaded with an inert, insulating or arc extinguishing gas, such as sulfur hexafluoride, nitrogen, hydrogen/nitrogen mix and the like. The inner housing 210 and the interior walls 224 enclose the carry contacts 202, 204 and the arc contacts 206, 208 so that any electric arc extending from the carry contacts 202, 204 is contained in the interior compartments 220 and that any electric arc extending from the arc contacts 206, 208 is contained in the interior compartments 222, thereby preventing any electrical arc from damaging other components of the contactor assembly 102. The interior walls 224 block or impede the straight line paths between the carry contacts 202, 204 and the arc contacts 206, 208, thereby physically shielding the carry contacts 202, 204 from electric arcs radiating from the arc contacts 206, 208 when the arc contacts 206, 208 initially close the circuit (shown in FIG. 4).

The interior walls 224 may prevent refractory material of the arc contacts 206, 208 from contaminating the carry contacts 202, 204. For example, refractory material from the arc contacts 206, 208 may be expelled from the arc contacts 206, 208 by arcs that emanate from the arc contacts 206, 208. The interior walls 224 block and prevent this material from reaching and contaminating the carry contacts 202, 204. Contamination of the carry contacts 202, 204 with refractory material from the arc contacts 206, 208 may increase the electrical resistance of the carry contacts 202, 204.

The contactor assembly 102 further includes an armature or actuator assembly 226 which has a central bore 228. The actuator assembly 226 is slidably positioned via a bearing 230. A movable electrical contact bridge 232 is attached to the central bore 228 and configured to be in selective communication with the carry contacts 202, 204 and the arc contacts 206, 208. The movable electrical contact bridge 232 may be divided to provide separate first electrical pathways 232b, 232c, 232d, for the carry contacts 202, 204 and separate second electrical pathways 232a, 232e for the arc contacts 206, 208. Each electrical pathway 232b, 232c, 232d of the contact bridge 232 has first conductive areas 240 positioned at either end thereof. Each electrical pathway 232a, 232e of the contact bridge 232 has second conductive areas 242 positioned at either end thereof.

The contact bridge 232 includes, or is formed from, a conductive material such as, but not limited to, one or more metals or metal alloys. The conductive areas 240 may be formed of the same material as the contact bridge 232 or may be formed from other conductive materials. For example, the conductive areas 240 may be formed from a silver (Ag) alloy. The conductive areas 242 may be formed from a metal or metal alloy that more resistant to heat and/or wear than the material(s) from which the conductive areas 240 are formed. For example, the conductive areas 242 may be formed from a refractory metal or refractory metal alloy, such as titanium (Ti), vanadium (V), chromium (Cr), zirconium (Zr), niobium (Nb), molybdenum (Mo), hafnium (Hf), tantalum (Ta), tungsten (W), or rhenium (Re). The conductive areas 240 may be formed from a metal or metal alloy that is more electrically conductive than the material(s) from which the conductive areas 242 are formed.

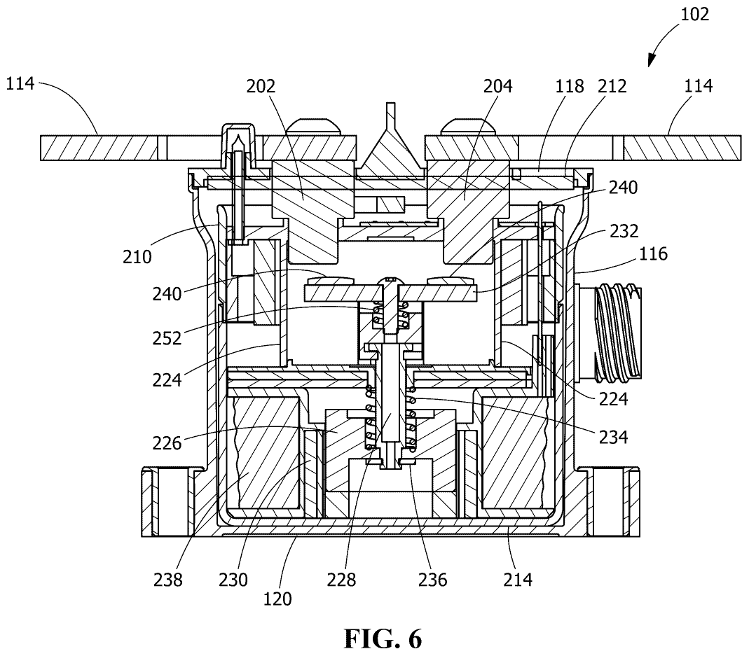

The actuator assembly 226 further includes an armature spring 234 which is configured to apply an armature spring force to the actuator assembly 226. The armature spring force may cause the actuator assembly 226 to slidably at least partially retract which may selectively position the actuator assembly 226 such that the electrical contact bridge 232 and the carry contacts 202, 204 and the arc contacts 206, 208 will not be in communication. A retaining clip 236 (FIG. 6) is added to an end of the central bore 228 to transfer an impact between the actuator assembly 226 and the electrical contact bridge 232 during movement of the actuator assembly 226, in order to allow for an increased parting force and velocity.

The contactor assembly 102 further includes an electrically conductive coil 238 which is configured to apply a magnetic force to the actuator assembly 226 in response to a coil current within the electrically conductive coil 238. The magnetic force may be in opposition to the armature spring force acting on the actuator assembly 226. The magnetic force may cause the actuator assembly 226 to move upward (as illustrated in FIGS. 4 through 7) to position the actuator assembly 226 such that the electrical contact bridge 232 and the arc contacts 206, 208 will be in communication and/or the electrical contact bridge 232 and the carry contacts 202, 204 and the arc contacts 206, 208 will be in communication. The rapidity of the mechanical movement of the actuator assembly 226, in response to the magnetic force, determines how quickly the contactor assembly 102 will respond to the application of the coil current.

As shown in FIGS. 1 through 3, a fuse housing 300 is provided outside of and is secured to the outer housing 116. In the illustrative embodiment shown, the fuse housing 300 is in the shape of a square box, but other configurations and positioning of the fuse housing may be used.

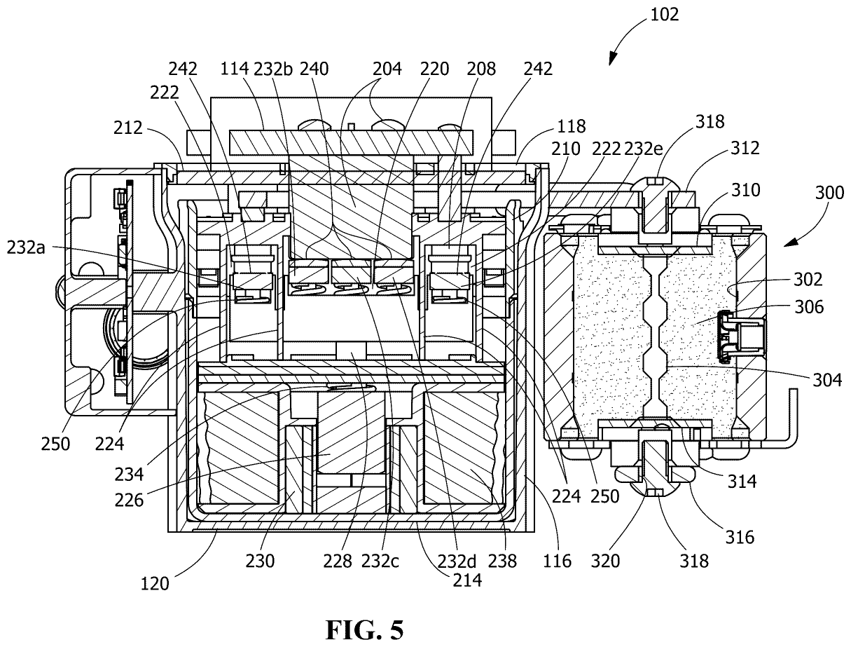

As is shown in FIGS. 4 and 5, the fuse housing 300 has an interior compartment 302 in which a overcurrent protection device or fuse assembly 304 is positioned. The particular fuse assembly 304 shown if FIGS. 4 and 5 is for illustrative purposes, as the overcurrent protection device or fuse assembly 304 may have various configurations. The interior compartment 302 may have insulative material 306 provided therein, or may have no additional material provided therein.

A first end 310 of the fuse assembly 304 is positioned in electrical engagement with a first electrically conductive member 312, such as, but not limited to, a bus bar or conductive wire. A second end 314 of the fuse assembly 304 is positioned in electrical engagement with a second electrically conductive member 316, such as, but not limited to, a bus bar or conductive wire. The first member 316 are also in electrical engagement with one or more of the arc contacts 206, 208.

In the illustrative embodiment, the fuse housing 300 and the fuse assembly 304 is secured to the contact assembly 102 by mounting hardware 318 which extends through openings 320 in the first electrically conductive member 312 and the second electrically conductive member 316. This allows the fuse housing 300 and the fuse assembly 304 to be removed and replaced if the fuse assembly 304 fails, as will be more fully described.

In operation, the actuator subassembly 226 moves in opposing directions along the longitudinal axis 122 to move the electrical pathway 232a, 232b, 232c, 232d, 232e of the contact bridge 232 toward the carry and arc contacts 202-208 and away from the carry and arc contacts 202-208. For example, the actuator subassembly 226 may move toward the contacts 202-208 to lift the electrical pathway 232a, 232b, 232c, 232d, 232d, 232e of the contact bridge 232 toward the carry and arc contacts 202-208. As this occurs the actuator subassembly 226 moves the electrical pathway 232a, 232b, 232c, 232d, 232e upward (as viewed in FIGS. 4 through 7) to mate the conductive areas 242 of the electrical pathway 232a, 232e with the arc contacts 206, 208 and to mate the conductive areas 240 of the electrical pathway 232b, 232c, 232d with the carry contacts 202, 204. As this occurs, the actuator assembly 226 is configured to cause the conductive areas 242 of the electrical pathway 232a, 232e to couple with the arc contacts 206, 208 prior to the conductive areas 240 of the electrical pathway 232b, 232c, 232d coupling with the carry contacts 202, 204. For example, the arc contacts 206, 208 are positioned below the carry contacts 202, 204 such that the conductive areas 242 engage the arc contacts 206, 208 prior to the conductive areas 240 engaging the carry contacts 202, 204.

The mating of the conductive areas 242 of the electrical pathway 232a, 232e with the arc contacts 206, 208 prior to the mating of the conductive areas 240 of the electrical pathway 232b, 232c, 232d with the carry contacts 202, 204 causes the arc contacts 206, 208 and the actuator subassembly 226 to close the before the actuator subassembly 226 electrically couples the carry contacts 202, 204. For example, the current supplied by the power source may pass through the arc contacts 206, 208 of the contactor assembly 102 prior to passing through the carry contacts 202, 204. As a result, the initial passage of the current through the arc contacts 206, 208 may cause any electric arcs that will be formed when the circuit is initially closed to propagate from the arc contacts 206, 208. Once the arc contacts 206, 208 have closed the circuit, the current may also pass across the carry contacts 202, 204 via the actuator subassembly 226.

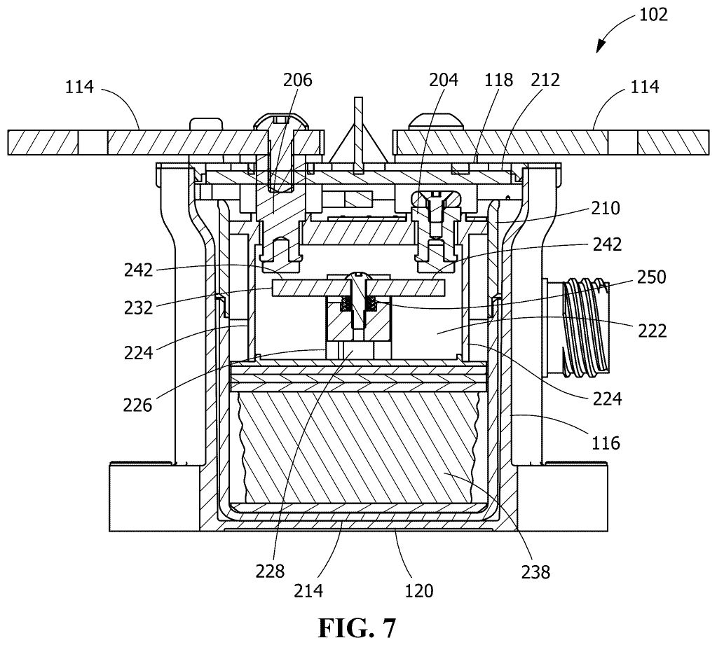

As shown in FIGS. 6 and 7, the contactor assembly 102 is in an open state because the actuator subassembly 226 is decoupled from the carry and arc contacts 202-208. The actuator subassembly 226 is separated from the contacts 202-208 such that none of the electrical pathway 232a, 232b, 232c, 232d, 232e of the contact bridge 232 interconnect or electrically join the carry contacts 202, 204 or the arc contacts 206, 208 with one another. As a result, current cannot pass across the arc contacts 206, 208 or the carry contacts 202, 204.

In order to drive the actuator subassembly 226 toward the contacts 202-208, the coil 238 is energized to create a magnetic field along the longitudinal axis 122. The magnetic field moves the actuator subassembly 226 toward the contacts 202-208 along the longitudinal axis 122. In the illustrated embodiment, an armature spring 234 exerts a force on the actuator subassembly 226 in a downward direction toward the end 120 of the outer housing 116. The force exerted by the armature spring 234 prevents the actuator subassembly 226 from moving toward and mating with the contacts 202-208 without the creation of a magnetic field by the coil 238. The magnetic field generated by the coil 238 is sufficiently large or strong so as to overcome the force exerted by the armature spring 234 and drive the actuator subassembly 226 toward the contacts 202-208.

Referring to FIG. 4, the contactor assembly 102 in a partially closed state in accordance with one embodiment of the present disclosure is shown. In the partially closed state, the actuator subassembly 226 has moved within the contactor assembly 102 along the longitudinal axis 122 sufficiently far that the electrical pathway 232a, 232e of the contact bridge 232 has mated with the arc contacts 206, 208, but has not advanced sufficiently far to mate the electrical pathway 232b, 232c, 232d of the contact bridge 232 with the carry contacts 202, 204. As a result, the actuator subassembly 226 has electrically coupled the arc contacts 206, 208 and closed the circuit across the arc contacts 206, 208. Conversely, the carry contacts 202, 204 remain decoupled from one another such that current cannot pass across the carry contacts 202, 204. Once the actuator subassembly 226 closes the circuit across the arc contacts 206, 208, current may pass through the contactor assembly 102 via the arc contacts 206, 208. The initial surge of current through the contactor assembly 102 may create an electrical arc emanating from one or more of the arc contacts 206, 208. As described above, the contactor assembly 102 prevents the arcs from passing from the arc contacts 206, 208 to the carry contacts 202, 204.

As previously described, the electrical pathways 232a, 232e of the contact bridge 232 are electrically engaged with the overcurrent protection device or fuse assembly 304 through first electrically conductive member 312 and the second electrically conductive member 314. The electrical pathways 232a, 232e, the first electrically conductive member 312, the second electrically conductive member 314 and the overcurrent protection device or fuse assembly 304 provide a pathway for arc dissipation from the arc contacts 206, 208. As the arc is directed as described, the arc is directed away from carry contacts 202, 204, thereby preventing damage to the arc contacts 202, 204.

If a large, unwanted power surge occurs while moving toward or in the open state, the arc generated by the power surge is directed through the electrical pathways 232a, 232e, the first electrically conductive member 312, and the second electrically conductive member 314 to the overcurrent protection device or fuse assembly 304. If the current flow is above the rated limited of the overcurrent protection device or fuse assembly 304, the overcurrent protection device or fuse assembly 304 will fail, thereby preventing the further current to be conveyed through the contact assembly 102 which prevents the sealed contactor assembly 102 from exploding from over-pressure. The overcurrent protection device or fuse assembly 304 prevents the contactor assembly 102 from experiencing a damaging blow out. As the overcurrent protection device or fuse assembly 304 is provided in the housing 300 which is located outside of the contactor assembly housing 116, the overcurrent protection device or fuse assembly 304 can be easily replaced to allow for continued operation of the contactor assembly 102.

In the illustrated embodiment, the actuator subassembly 226 includes arc springs 250 positioned proximate the contact areas 242 of electrical pathway 232a, 232e of the contact bridge 232 and carry springs 252 positioned proximate the contact areas 240 of electrical pathway 232b, 232c, 232d of the contact bridge 232. Once the actuator subassembly 226 is driven along the longitudinal axis 122 to mate the electrical pathway 232a, 232e of the contact bridge 232 with the arc contacts 206, 208, continued movement of the actuator subassembly 226 along the longitudinal axis 122 may compress the arc springs 250.

Referring to FIG. 5, the contactor assembly 102 in a fully closed state in accordance with one embodiment of the present disclosure is shown. In the closed state, the actuator subassembly 226 has moved within the contactor assembly 102 along the longitudinal axis 122 sufficiently far that the electrical pathway 232a, 232e of the contact bridge 232 are mated with the arc contacts 206, 208 and the electrical pathway 232b, 232c, 232d of the contact bridge 232 are mated with the carry contacts 202, 204. As a result, the actuator subassembly 226 has electrically coupled the arc contacts 206, 208 and electrically coupled the carry contacts 202, 204 to close the circuit across both the arc contacts 206, 208 and the carry contacts 202, 204. As a result, the current passing through the circuit may propagate through the contactor assembly 102 across or through all of the contacts 202-208.

As previously described, the electrical pathways 232a, 232e of the contact bridge 232 are electrically engaged with the overcurrent protection device or fuse assembly 304 through first electrically conductive member 312 and the second electrically conductive member 314. The electrical pathways 232a, 232e, the first electrically conductive member 312, the second electrically conductive member 314 and the overcurrent protection device or fuse assembly 304 provide a pathway for arc dissipation from the arc contacts 206, 208. As the arc is directed as described, the arc is directed away from carry contacts 202, 204, thereby preventing damage to the arc contacts 202, 204.

If a large, unwanted power surge occurs while moving toward or in the open state, the arc generated by the power surge is still directed through the electrical pathways 232a, 232e, the first electrically conductive member 312, and the second electrically conductive member 314 to the overcurrent protection device or fuse assembly 304. As previously described, if the current flow is above the rated limited of the overcurrent protection device or fuse assembly 304, the overcurrent protection device or fuse assembly 304 will fail, thereby preventing the further current to be conveyed through the contact assembly 102 which prevents the sealed contactor assembly 102 from exploding from over-pressure. The overcurrent protection device or fuse assembly 304 prevents the contactor assembly 102 from experiencing a damaging blow out. As the overcurrent protection device or fuse assembly 304 is provided in the housing 300 which is located outside of the contactor assembly housing 116, the overcurrent protection device or fuse assembly 304 can be easily replaced to allow for continued operation of the contactor assembly 102.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A contactor assembly adapted for switching power to a circuit having a power source, the contactor assembly comprising:
a housing defining an interior compartment;
carry contacts positioned in the interior compartment of the housing;
arc contacts positioned in the interior compartment, at least one arc contact having an overcurrent protection device positioned outside of the interior compartment of the housing;
an actuator assembly movable between an open position and a closed position;
wherein as the actuator assembly is moved toward the closed position, the actuator assembly makes an electrical connection with the arc contacts prior to making an electrical connection with the current carry contacts.

2. The contactor assembly as recited in claim 1, wherein the carry contacts are one or more sets of electrical carry contacts.

3. The contactor assembly as recited in claim 2, wherein the arc contacts are one or more sets of electrical arc contacts, the arc contacts close the circuit before the carry contacts.

4. The contactor assembly as recited in claim 1, wherein the contactor assembly has an inner housing which is disposed in an outer housing, the interior compartment is positioned in the inner housing, the carry and arc contacts protrude through an end of the inner housing to be presented at the end of the outer housing.

5. The contactor assembly as recited in claim 4, wherein the inner housing includes a carry contact interior compartment and one or more arc contact interior compartments, the carry contact interior compartment and the one or more arc contact interior compartments are separated by interior walls.

6. The contactor assembly as recited in claim 5, wherein the interior walls may are formed from a dielectric material or other insulative materials.

7. The contactor assembly as recited in claim 6, wherein the carry contacts are disposed in the carry contact interior compartment and the arc contacts are disposed in the arc contact interior compartments.

8. The contactor assembly as recited in claim 1, wherein the actuator assembly has an electrical contact bridge attached to a central bore, the electrical contact bridge is configured to be in selective communication with the carry contacts and the arc contacts.

9. The contactor assembly as recited in claim 8, wherein the electrical contact bridge is divided to provide separate first electrical pathways for the carry contacts and separate second electrical pathways for the arc contacts.

10. The contactor assembly as recited in claim 9, wherein the first electrical pathways have first conductive areas positioned at either end thereof and the second electrical pathways have second conductive areas positioned at either end thereof.

11. The contactor assembly as recited in claim 1, wherein the overcurrent protection device is positioned in an overcurrent protection device housing provided outside of the housing of the contactor assembly.

12. The contactor assembly as recited in claim 11, wherein the overcurrent protection device housing has an interior compartment in which the overcurrent protection device is positioned.

13. The contactor assembly as recited in claim 11, wherein the overcurrent protection device is a fuse.

14. The contactor assembly as recited in claim 1, wherein a first end of the overcurrent protection device is positioned in electrical engagement with a first electrically conductive member and a second end of the overcurrent protection device is positioned in electrical engagement with a second electrically conductive member.

15. The contactor assembly as recited in claim 14, wherein the first electrically conductive member and the second electrically conductive member are provided in electrical engagement with one or more of the arc contacts.

16. The contactor assembly as recited in claim 14, wherein the first electrically conductive member and the second electrically conductive member are bus bars.

17. A contactor assembly adapted for switching power to a circuit having a power source, the contactor assembly comprising:
a housing defining an interior compartment;
carry contacts positioned in the interior compartment of the housing;
arc contacts positioned in the interior compartment, at least one arc contact having an overcurrent protection device positioned outside of the interior compartment of the housing, the overcurrent protection device is positioned in an overcurrent protection device housing provided outside of the housing of the contactor assembly;
an actuator assembly movable between an open position and a closed position, the actuator assembly having an electrical contact bridge configured to be in selective communication with the carry contacts and the arc contacts;
wherein as the actuator assembly is moved toward the closed position, the actuator assembly makes an electrical connection with the arc contacts prior to making an electrical connection with the current carry contacts;
wherein as the actuator assembly is moved toward the open position, the actuator assembly maintains an electrical connection with the arc contacts after breaking an electrical connection with the current carry contacts, prior to breaking the electrical connection with the arc contacts.

18. The contactor assembly as recited in claim 17, wherein a first end of the overcurrent protection device is positioned in electrical engagement with a first electrically conductive member and a second end of the overcurrent protection device is positioned in electrical engagement with a second electrically conductive member.

19. The contactor assembly as recited in claim 18, wherein the first electrically conductive member and the second electrically conductive member are provided in electrical engagement with one or more of the arc contacts.

20. The contactor assembly as recited in claim 19, wherein the overcurrent protection device is a fuse.
